(19) United States
(12) Patent Application Publication
(10) Pub. No.: US 2006/0285711 A1
(43) Pub. Date: Dec. 21, 2006

(54) Horn speaker

(76) Inventor: Jong Seok Song, Busan (KR)

Correspondence Address: IPLA P.A., 3580 WILSHIRE BLVD., 17TH FLOOR, LOS ANGELES, CA, 90010, US

(21) Appl. No.: 10/548,330

(22) PCT Filed: Feb. 17, 2004
(86) PCT No.: PCT/KR04/00315

§ 371 Date: Sep. 7, 2005

(30) Foreign Application Priority Data
Jul. 3, 2003 (KR) 10-2003-0014266

(51) Int. Cl. H04R 1/02

(52) U.S. Cl. 381/340

(57) ABSTRACT

The present invention relates to a horn speaker, and in particular to a horn speaker capable of decreasing the length of a horn by forming a sound path in a curved shape in the interior of a horn. The horn speaker includes a first sound path, a second sound path formed in a shape of surrounding the first sound path, and a third sound path formed in a ring shape. The sound paths formed in the interior of the horn is curved, so that the length of the horn is decreased as compared to the conventional horn in which a straight line shaped sound path is formed.

### TECHNICAL FIELD

The present invention relates to a horn speaker, and in particular to a horn speaker capable of decreasing the length of a horn by forming sound paths in a curved shape in the interior of a horn.

### BACKGROUND ART

A speaker is a sound instrument capable of outputting sound waves by changing an electric sound signal into vibration of a vibration plate and generating a densely wave in the air. The speaker is classified into a direct spreading type speaker in which a vibration plate is directly placed in the air and a horn speaker in which a vibration plate is placed in the interior of a horn.

The horn speaker is one of the most efficiency speaker and has been widely used for a portable speaker that needs an alarming siren and low power. The horn speaker is formed of a horn and an electric sound conversion unit. When a vibration plate of the electric sound conversion unit is vibrated by a piezo-electric element, it is called a piezo-electric horn speaker, and when it is vibrated by a voice coil vibrating by an electromagnetic force is called a dynamic type horn speaker.

The conventional piezo-electric type horn speaker will be described with reference to FIG. 1.

As shown therein, the piezo-electric type speaker 10 is formed of a horn 11 and an electric sound conversion unit 16. The horn 11 a conical shaped frame 13 having a neck part 13a and an opening 13b, and an engaging tube 14 outwardly extended from the neck part 13a and engaged with the electric sound conversion unit 16. The electric sound conversion unit 16 includes a vibration plate 17 engaged to the engaging tube 14 at a distance from the neck part 13a, a piezo-electric device 18 closely engaged with the vibration plate 17, and a cover 19 surrounding the vibration plate 17 and the piezo-electric device 18 and being engaged to the engaging tube 14. In the drawings, reference numeral 15 represents an equalizer adapted to enhance an efficiency of the speaker by correcting so that a center portion and an outer portion of the vibration plate 17 are uniformly vibrated.

The operation of the conventional piezo-electric horn speaker will be described.

When voltage is applied to the piezo-electric device 18, the vibration plate 17 vibrates. As the vibration plate 17 vibrates, the density of the air in the interior of the frame 13 gets gradually released by the vibrations of the vibration plate 17. Namely, the density of the air gets gradually released in the direction from the neck part 13a to the opening 13b, so that sound waves are spread in the air for thereby generating large sound.

In the efficiency of the horn speaker, the matching property with the air is enhanced as the length of the horn is increased for thereby enhancing the efficiency. It is impossible to fabricate a horn having a certain longer length. It is very difficult to carry and install the speaker having a lengthy horn. In addition, the horn has a certain cross section that is gradually increased in the left and right directions with respect to the neck part. It is very difficult to fabricate the horn having the above-described construction.

In order to overcome the above problems, a horn speaker having a bent horn without decreasing the visual length of the horn is developed. However, it is not easy to fabricate, install and carry the above-described horn.

### DISCLOSURE OF INVENTION

### Technical Solution

Accordingly, it is an object of the present invention to provide a horn speaker capable of overcoming the problems encountered in the conventional art.

It is another object of the present invention to provide a horn speaker capable of decreasing the length of a horn by forming a sound path in a curved shape in the interior of the horn.

To achieve the above objects, there is provided a horn speaker including an electric sound conversion unit having a vibration plate for generating electric sound signals, and a horn having a path for sound generated by vibrations of a vibration plate wherein the electric sound conversion unit is engaged to a front side of the same, and the center of the vibration plate is matched with the center of the same, comprising a first sound path in which in the interior of the horn, a front side communicates with a front outer side of the horn, and a rear side is positioned in the interior of the rear side of the horn, and the cross sectional area is gradually increased in the direction from the front side of the horn to the rear side; a second sound path formed in a shape of surrounding the first sound path, in which the rear side communicates with the rear side of the first sound path, and the front side is positioned in the interior of the front side of the horn, and the cross sectional are is gradually increased in the direction from the rear side of the horn to the front side, wherein it is formed in a ring shape; and a third sound path formed in a ring shape, in which it is formed in a shape of surrounding the second sound path, and the front side communicates with the front side of the second sound path, and the rear side communicates with the rear outer side of the horn, and the cross sectional area is gradually increased in the direction from the front side of the horn to the rear side.

### DESCRIPTION OF DRAWINGS

The preferred embodiments of the present invention will be described with reference to the accompanying drawings.

FIG. 1 is a cross sectional view illustrating a conventional piezo-electric type horn speaker;

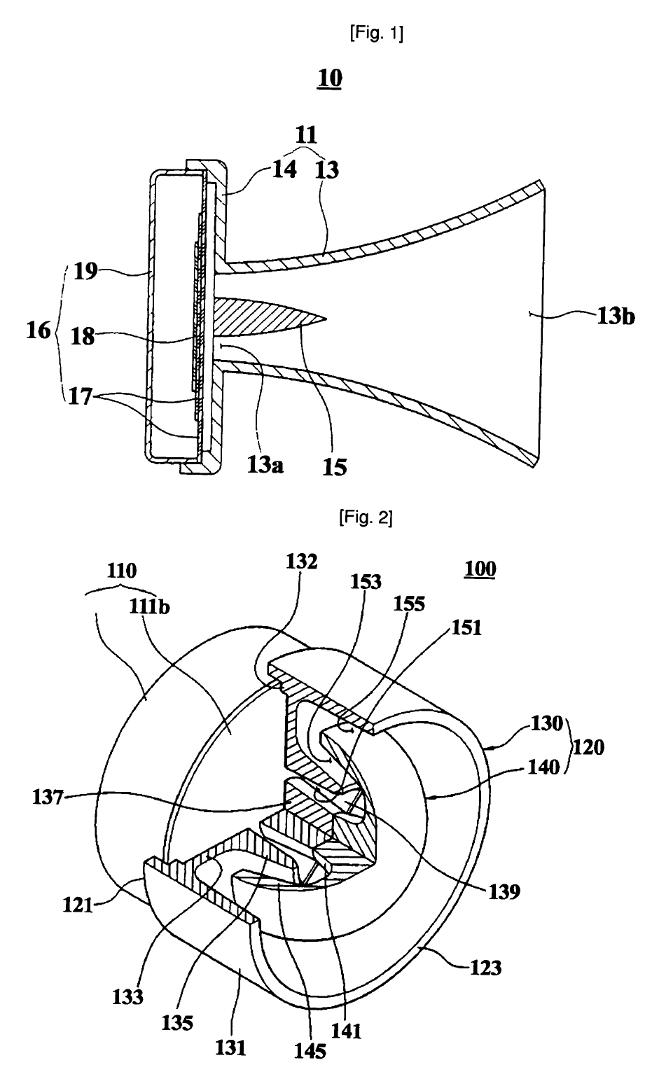

FIG. 2 is a perspective view illustrating a piezo-electric type horn speaker according to an embodiment of the present invention;

FIG. 3 is a partially cut-away disassembled perspective view of the horn of FIG. 2;

FIG. 4 is an engaged cross sectional view of FIG. 3;

FIG. 5 is a graph of a sound pressure-frequency characteristic of a piezo-electric type horn speaker according to an embodiment of the present invention;

FIGS. 6 and 7 are partially cut-away disassembled perspective view of a piezo-electric type horn speaker according to another embodiment of the present invention; and

FIG. 8 is a cross sectional view illustrating a dynamic type horn speaker according to further another embodiment of the present invention.

### BEST MODE

The horn speaker according to a preferred embodiment of the present invention will be described with reference to the accompanying drawings.

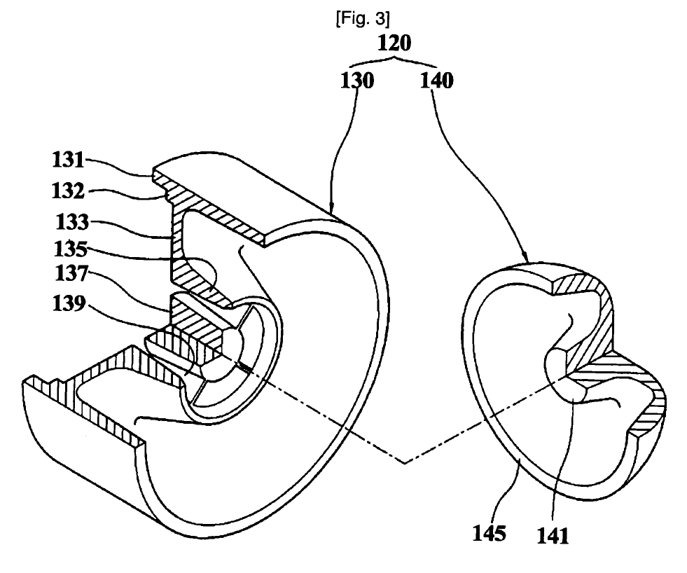

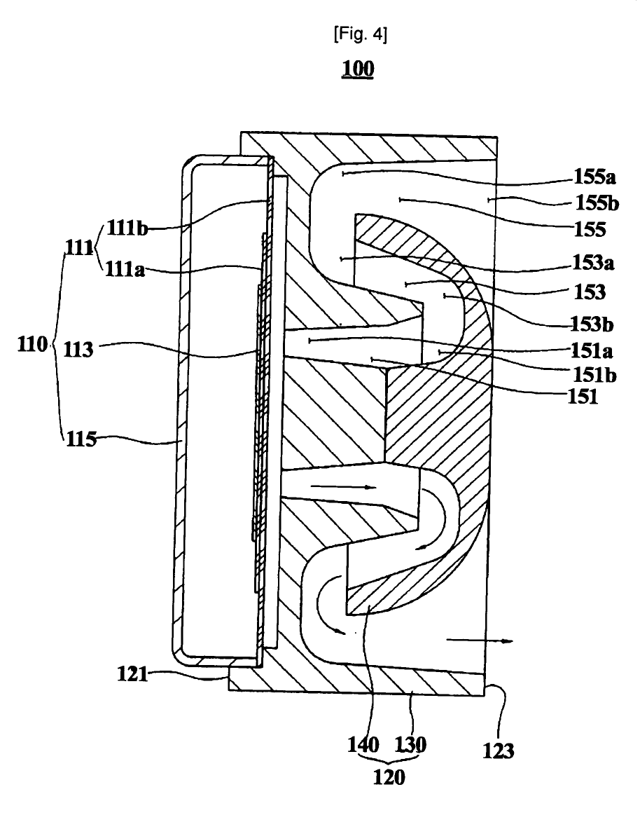

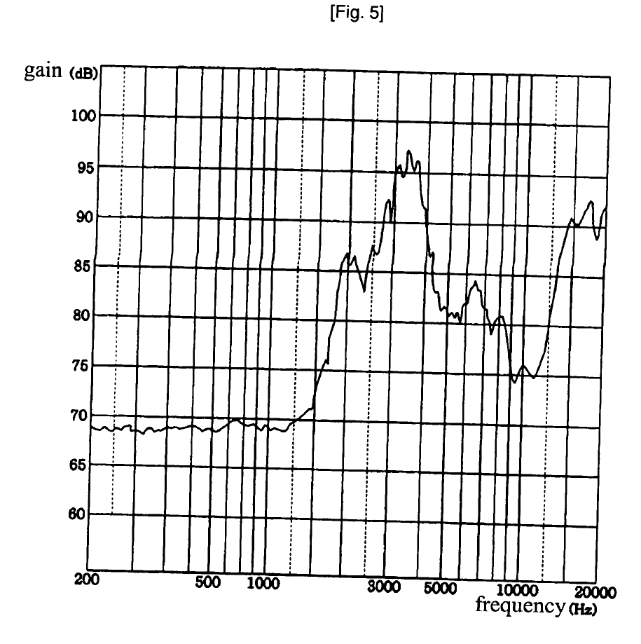

FIG. 2 is a perspective view illustrating a piezo-electric type horn speaker according to an embodiment of the present invention, FIG. 3 is a partially cut-away disassembled perspective view of the horn of FIG. 2, and FIG. 4 is an engaged cross sectional view of FIG. 3.

As shown therein, the horn speaker 100 according to an embodiment of the present invention includes an electric sound conversion unit 110 capable of generating electric sound signals, and a horn 120 having a path for sound generated by the electric sound conversion unit 110.

The electric sound conversion unit 110 includes a vibration plate 111 having a metal vibration plate 111a and a paper vibration plate 111b, a piezo-electric device 113 closely engaged to the vibration plate 111 for vibrating the vibration plate 113 when voltage is applied, and a cover 115 adapted to surround the vibration plate 111 and the piezo-electric device 113 and to prevent sound from being spread in the front side of the cover 115.

The horn 120 is formed in a cylindrical shape and includes ring shaped first, second and third sound paths 151, 153 and 155 communicating with each other. The front side 151a of the first sound path 151 communicates with the outer portion of the front side 121 of the horn 120, and the rear side 151b of the same is positioned in the interior of the rear side 123 of the horn 120. The cross sectional area of the first sound path 151 gets wider in the direction from the front side 121 of the horn 120 to the rear side 123. The second sound path 153 is formed to surround the first sound path 151, and the rear side 153b communicates with the rear side 151b of the first sound path 151. The front side 153a is positioned in the interior of the front side 121 of the horn 120. The cross sectional area of the second sound path 153 gets wider in the direction from the rear side 123 of the horn 120 to the front side 121. The third sound path 155 is formed to surround the second sound path 153, and the front side 155a communicates with the front side 153a of the second sound path 153, and the rear side 155b communicates with the outer portion of the rear side 123 of the horn 120. The cross sectional area of the third sound path 155 gets wider in the direction from the front side 121 of the horn 120 to the rear side 123.

The horn 120 includes a frame 130 and a spreading plate 140 that are engaged with each other and are provided in such a manner that the ring shaped first, second and third sound paths 151, 153 and 155 are easily formed.

The frame 130 includes an outer plate 131, a connection plate 133, an inner plate 135, an equalizer 137 and a connection rib 139.

The outer plate 131 is provided in a ring shape having a certain width, and the paper vibration plate 111b and the cover 115 are inserted and engaged to the inner surface of the front side. At this time, the center of the outer plate 131 and the center of the vibration plate 111 are positioned on the coaxial portion. The connection plate 133 is extended from the inner surface of the outer plate 131 in the direction of the center of the outer plate 131 in a ring shape. A step surface 132 contacting with a rim portion of the vibration plate 111 is formed in the inner surface of the front side of the outer plate 131. The step surface 132 is provided in such a manner that a certain distance is provided between the vibration plate 111 and the connection plate 133, and a certain space is formed between the vibration plate 111 and the connection plate 133. The inner plate 135 has a certain width and is provided in a ring shape and is extended in the direction from the inner surface of the connection plate 133 to the rear side of the outer plate 131. The center of the inner plate 135 is matched with the center of the outer plate 131. A groove is formed between the outer plate 131 and the inner plate 135. The equalizer 137 is formed in a cylindrical shape and is arranged in the center of the inner plate 135 and has a certain distance from the inner surface of the inner plate 135. Therefore, a first sound path 151 is formed between the inner surface of the inner plate 135 and an outer surface of the equalizer 137. The front side 111a of the first sound path 151 communicates with the outer portion of the front side 121 of the horn 120. The equalizer 137 restricts the separation vibration of the vibration plate 111, so that the vibration plate 111 uniformly vibrates. Since the equalizer 137 is positioned in the center of the inner plate 135, the centers of the equalizer 137 and the vibration plate 111 are matched. The connection rib 137 is provided in the radial direction by at least two and integrally connects the equalizer 137 and the inner plate 135.

The spreading plate 140 has an engaging protrusion 141 and a wing part 145.

The engaging protrusion 141 is provided in a cylindrical shape. The front side of the engaging protrusion 141 corresponds to the rear side of the equalizer 137 and is closely contacted with the rear side of the equalizer 137.

The wing part 145 is formed in an umbrella shape with respect to the engaging protrusion 141 in one outer side of the engaging protrusion 141 and is provided between the outer plate 131 and the inner plate 135. Therefore, a groove is formed between the engaging protrusion 141 and the wing part 145, and a second sound path 153 is formed between the inner surface of the wing part 145 and the outer surface of the inner plate 135. A third sound path 155 is formed between the outer surface of the wing part 145 and the inner surface of the outer plate 131.

The outer diameter of the equalizer 137 is gradually decreased in the direction from the front side 121 of the horn 120 to the rear side 123. The inner diameter of the inner plate 135 is gradually increased in the direction from the front side 121 of the horn 120 to the rear side 123. The outer diameter of the inner plate 135 is gradually decreased in the direction from the front side 121 of the horn 120 to the rear side 123. The inner diameter of the outer plate 131 is gradually increased in the direction from the front side of the horn 120 to the rear side 123. The portion in which the connection plate 133 and the inner plate 135 meet each other and the portion in which the connection plate 133 and the outer plate 131 meet each other are rounded, respectively. The outer diameter of the engaging protrusion 141 is gradually increased in the direction from the front side 121 of the horn 120 to the rear side 123. The portion in which the engaging protrusion 141 and the wing part 145 meet each other is rounded.

The operation of the horn speaker according to an embodiment of the present invention will be descried with reference to the accompanying drawings.

When voltage is applied to the piezo-electric device 113, the vibration plate 111 vibrates. The air between the vibration plate 111 and the connection plate 133 receives a certain energy from the vibration plate 111 as the vibration plate 111 vibrates, so that the density of the air in the interior of the horn 120 is sequentially released along the first, second, third sound paths 151, 153, 155. Therefore, sound waves are spread from the rear end of the third sound path 155 for thereby generating big sound.

In the horn speaker 100 according to an embodiment of the present invention, the sound resistance of the horn 120 operates as a load with respect to the vibration plate 111. In addition, the cross sectional area of the first sound path 151 in the front side 121 of the horn 120 is smaller than the area of the vibration plate 111. The vibration plate 111 and the first sound path 151 are overlapped each other. The load sound impedance of the vibration plate 111 is increased for thereby getting closer to the mechanical impedance of the vibration plate 111. The cross sectional area of the first, second and third sound paths 151, 153 and 155 are gradually increased in the spreading direction of the sound, so that the impedance matching between the rear end 155b of the third sound path 155 and the outer space of the rear side 123 of the horn 120 is enhanced for thereby enhancing the efficiency.

As described above, the first, second and third sound paths 151, 153 and 155 of the horn speaker 100 according to an embodiment of the present invention are provide in a curved shape, communicating with each other. Therefore, it is possible to decrease the length of the horn 120 and to increase the length of the sound paths.

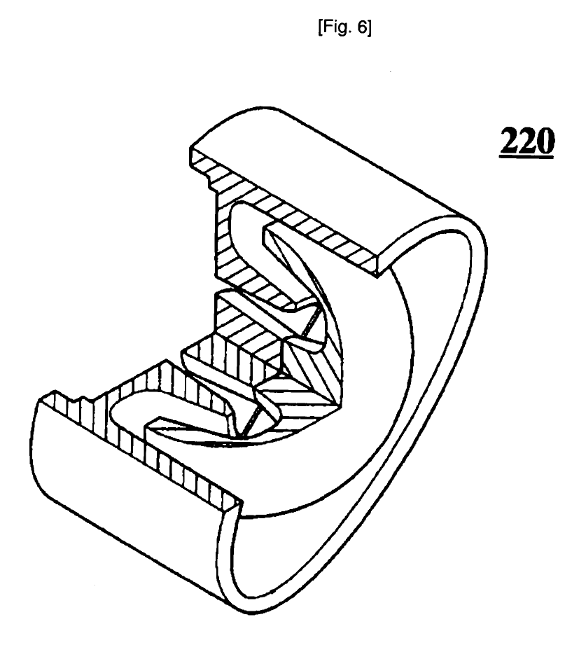

FIGS. 4 and 5 shows a result of the tests obtained by measuring the sound pressure—frequency characteristic by fabricating the piezo-electric horn speaker 100 according to an embodiment of the present invention. FIG. 5 is a graph of the sound pressure—frequency characteristic of the piezo-electric horn speaker according to an embodiment of the present invention.

The length of the horn 120 of the piezo-electric horn speaker 100 fabricated according to an embodiment of the present invention is 20 mm, and the length of the first, second and third sound paths 151, 153 and 155 is 56 mm, and the diameter and cross sectional area of the third sound path 155 in the rear side 121 of the horn 120 is 50 mm and 1500 mm², respectively. In addition, the values of the paths gradually expanding in the proceeding direction of the first, second and third sound paths 151, 153 and 155 is determined as an intermediate value between the exponent function horn and the high public horn, and the disconnection frequency is 1.4 KHz, and an electric sound signal of 0.1 W is applied.

As shown in FIG. 5, the sound has a sound pressure of 95 dB at a frequency of 3 KHz, so that it is possible to obtain a high efficiency sound.

In the conventional horn speaker structure, the length of the horn should be 56 mm in order to have 56 mm of the length of the sound path. In the present invention, the horn speaker has a sound path length of 56 mm, and the length of the horn 120 is 20 mm, so that it is possible to decrease the length of the horn 120 by ⅓ as compared to the conventional art.

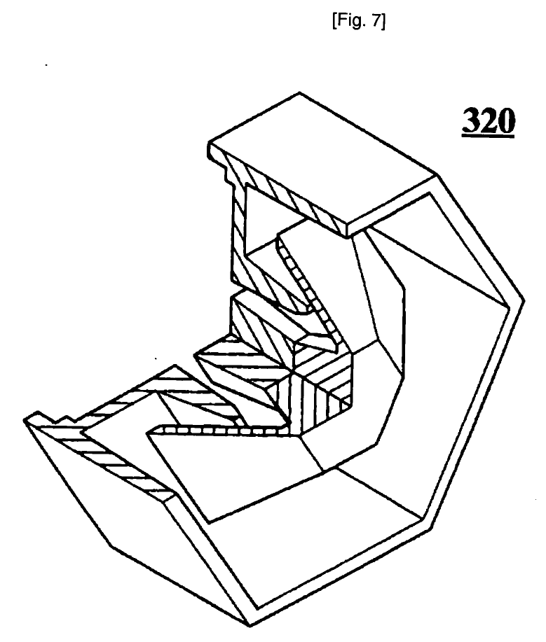

FIGS. 6 and 7 are partially cut-away disassembled perspective views of the horn of the piezo-electric horn speaker according to another embodiment of the present invention. As shown in FIG. 6, in the horn speaker, the horn 220 is formed in an elliptical shape. As shown in FIG. 7, in the horn speaker, the horn 320 is formed in a polygonal shape.

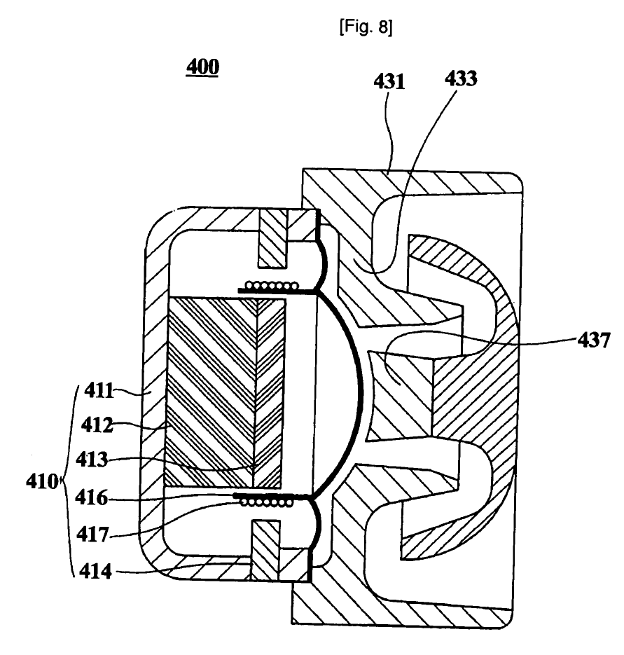

FIG. 8 is a cross sectional view of the dynamic horn speaker according to further another embodiment of the present invention. The construction of the same will be described.

As shown therein, the electric sound conversion unit 410 of the horn speaker 400 includes a cylindrical yoke 411 of which one side is opened, and the opened side is inserted into and engaged to the inner surface of the outer plate 431, a circular plate shaped magnet 412 and a circular plate shaped pole piece 413 sequentially stacked in the interior of the yoke 411 at a certain distance from the inner surface of the yoke 411, a plate 414 provided in a ring shape and installed in the yoke 411 in a shape of surrounding the pole piece 413 at a certain distance from the outer surface of the pole piece 413, a vibration plate 416 of which a rim side is engaged to the opened side of the yoke 411, and a voice coil 417 of which one side is supported by the vibration plate 416, and the other side is provided between the pole piece 413 and the plate 414. When the voltage is applied to the voice coil 417, the voice coil 417 vibrates based on the inter-operation between the voice coil 417, the magnet 412 and the pole piece 413 and the plate 414. Therefore, the vibration plate 416 vibrates for thereby generating sound. At this time, the connection plate 433 opposite to the vibration plate 416 and the equalizer 437 are correspond to the vibration plate 416.

### INDUSTRIAL APPLICABILITY

As described above, in the horn speaker according to the present invention, the sound paths formed in the interior of the horn is curved, so that the length of the horn is decreased as compared to the conventional horn in which a straight line shaped sound path is formed.

In addition, when the cylindrical frame and the umbrella spreading plate are separately fabricated and engaged each other, it is possible to fabricate the horn having the curved sound paths therein for thereby implementing an easier fabrication.

As the present invention may be embodied in several forms without departing from the spirit or essential characteristics thereof, it should also be understood that the above-described examples are not limited by any of the details of the foregoing description, unless otherwise specified, but rather should be construed broadly within its spirit and scope as defined in the appended claims, and therefore all changes and modifications that fall within the meets and bounds of the claims, or equivalences of such meets and bounds are therefore intended to be embraced by the appended claims.

1. A horn speaker including an electric sound conversion unit having a vibration plate for generating electric sound signals, and a horn having a path for sound generated by vibrations of a vibration plate wherein the electric sound conversion unit is engaged to a front side of the same, and the center of the vibration plate is matched with the center of the same, a horn speaker, comprising:
a first sound path in which in the interior of the horn, a front side communicates with a front outer side of the horn, and a rear side is positioned in the interior of the rear side of the horn, and the cross sectional area is gradually increased in the direction from the front side of the horn to the rear side;
a second sound path formed in a shape of surrounding the first sound path, in which the rear side communicates with the rear side of the first sound path, and the front side is positioned in the interior of the front side of the horn, and the cross sectional are is gradually increased in the direction from the rear side of the horn to the front side, wherein it is formed in a ring shape; and
a third sound path firmed in a ring shape, in which it is formed in a shape of surrounding the second sound path, and the front side communicates with the front side of the second sound path, and the rear side communicates with the rear outer side of the horn, and the cross sectional area is gradually increased in the direction from the front side of the horn to the rear side.

2. The speaker of claim 1, wherein said horn is formed in a ring shape and includes: an outer plate in which one side of the electric sound conversion unit and the vibration plate are inserted into and engaged to the interior of the front side;
a ring shaped connection plate extended from the inner side of the outer plate at a distance from the vibration plate in the direction of the center of the outer plate;
a ring shaped inner plate extended from the inner side of the connection plate in the direction of the outer side of the outer plate so that a groove is formed between the outer plate and the same and being concentric with respect to the outer plate;
a cylindrical equalizer provided in the inner center of the inner plate so that the first sound path is armed between the inner surface of the inner plate and the outer surface of the same;
a frame having a connection rib capable of integrally connecting the equalizer and the inner plate; and
a spreading plate having a wing part between the outer plate and the inner plate and constructed in such a manner that a second sound path is formed in an umbrella shape with respect to the engaging protrusion in one outer side of the engaging protrusion so that a groove is formed between the engaging protrusion and the same and is formed between the outer side of the inner plate and the inner side of the same, and a second sound path formed between the outer side of the same and the inner side of the outer plate,
wherein the centers of the first, second and third sound paths and the equalizer are positioned on the coaxial line, respectively.

3. The speaker of claim 2, wherein the outer diameter of the equalizer is gradually decreased in the direction from the front side of the horn to the rear side, and the inner diameter is gradually increased in the direction from the front side of the horn to the rear side, and the outer diameter of the inner plate is gradually decreased in the direction from the front side of the horn to the rear side, and the inner diameter of the outer plate is gradually increased in the direction from the front side of the horn to the rear side, and the portion in which the connection plate and the inner plate meet each other and the portion in which the connection plate and the outer plate meet each other are rounded, and the outer diameter of the engaging protrusion is gradually increased in the direction from the front side of the horn to the rear side, and the portion in which the engaging protrusion and the wing part meet each other is rounded.

4. The speaker of claim 2, wherein a step surface is firmed in the inner front side of the outer plate wherein the rim portion of the vibration plate contacts with the step surface, so that the vibration plate and the connection plate are supported at a certain distance between the same.
